(19) United States
(12) Patent Application Publication
(10) Pub. No.: US 2026/0037773 A1
(43) Pub. Date: Feb. 5, 2026

(54) Methods And Systems For Training Neural Networks To Classify Files Into File Classes

(71) Applicant: Siemens Aktiengesellschaft, München (DE)

(72) Inventor: Johannes Zwanzger, Neubiberg (DE)

(73) Assignee: Siemens Aktiengesellschaft, München (DE)

(21) Appl. No.: 19/099,547

(22) PCT Filed: Jul. 25, 2023
(86) PCT No.: PCT/EP2023/070613

§ 371 Date: Jan. 29, 2025

(30) Foreign Application Priority Data
Jul. 29, 2022 (EP) 22187801.0

(51) Int. Cl. G06N 3/044

(52) U.S. Cl. CPC G06N 3/044

(57) ABSTRACT

Various embodiments of the teachings herein include a method for training a first neural network to classify files into file classes. An example includes: assigning each file of a plurality of test files to a file class; breaking down each of the files into bit sequences assigned to the previously associated file class; and training the neural network using the bit sequences.

### CROSS-REFERENCE TO RELATED APPLICATIONS

This application is a U.S. National Stage Application of International Application No. PCT/EP2023/070613 filed Jul. 25, 2023, which designates the United States of America, and claims priority to EP Application Ser. No. 22/187801.0 filed Jul. 29, 2022, the contents of which are hereby incorporated by reference in their entirety.

### TECHNICAL FIELD

The present disclosure relates to training neural networks to classify files into file classes. Various embodiments of the teachings herein include systems and/or methods for classifying files into file classes.

### BACKGROUND

In the field of IT security, i.e. information security and/or functional safety, the problem of classifying files arises regularly. As such, malicious code in a file may be disguised using a protective tool. Identified prior application of a protective tool to a file can therefore indicate that IT security is impaired. Classification of files can spot whether or not such a protective tool has been used. As such, a file can be protected using security tools or can remain unprotected. Processing such files, for instance in the domain of production and/or automation facilities, requires such classification into file classes on a regular basis. Classifying of files, also referred to as classification of files within the context of the present disclosure, means the assignment of a file to precisely one of two or more predefined file classes. If there are precisely two file classes, the term ‘binary classification’ is used, otherwise the term ‘multinomial classification’ is used. In the case of binary classification, one possibility is for file classes to form endpoints of a continuous scale, for instance a continuous scale between the endpoints “large file” and “small file” when classifying file lengths, a clear, unique classification being possible only in the end regions of the continuous scale in this example.

A unique classification can also be provided on the basis of information about the presence or absence of a specific property, however: that is to say that either a property is present or the property is not present. Such a property may be the property “file contains ASCII text”, for instance, which is either present or not present. In the case of multinomial classification, the file classes can be categorized into more than two file classes. As such, preselected file types can form such file classes, for instance the file types “Excel file”, “PDF file” and “JPEG file”.

It is known practice to carry out such classification in such a way that the file to be classified looks for the string ‘% PDF’ at the beginning of the file. Such classification is possible so long as the string occurs in the file in precisely this form. For new versions of file types, though, such strings can change slightly. Such classification no longer works when strings change, however.

Neural networks can also be used to classify files. With continued training, neural networks are also geared to recognizing such strings, however, and so the use of neural networks has no significant advantage in this respect.

### SUMMARY

Teachings of the present disclosure include systems and methods for training a neural network to classify files into file classes that is improved over the prior art and also an improved method for classifying files into file classes and to specify a file classification device. For example, embodiments of the teachings herein include a method for training a first neural network (NN) to classify files (FIL) into file classes (CLA0, CLA1), wherein a plurality of test files (Xᵤ₁, Xᵤ₂, Xᵤ₃, Xₚ₁, Xₚ₂, Xₚ₃) are used, each of which is assigned to a file class, each of the test files (Xᵤ₁, Xᵤ₂, Xᵤ₃, Xₚ₁, Xₚ₂, Xₚ₃) being broken down into bit sequences (BIF) that remain assigned to the previously associated file class (CLA0, CLA1), and the neural network (NN) being trained using the bit sequences (BIF).

In some embodiments, the test files (Xᵤ₁, Xᵤ₂, Xᵤ₃, Xₚ₁, Xₚ₂, Xₚ₃) are broken down into bit sequences (BIF) completely.

In some embodiments, the neural network (NN) is trained using the bit sequences (BIF) in an unordered succession, in particular in a randomized succession.

In some embodiments, the first neural network (NN) is a recurrent neural network (NN).

As another example, some embodiments include a method for classifying at least one file (FIL) into file classes, wherein a first neural network (NN) that has been or is trained using a method as claimed in one of the preceding claims is used and wherein at least two different segments from the file (FIL) in the form of bit sequences (BIF) are used and the bit sequences (BIF) are each classified into candidate file classes using the neural network (NN), and the candidate file classes are taken as a basis for determining a file class (CLA0, CLA1).

In some embodiments, the training files (Xᵤ₁, Xᵤ₂, Xᵤ₃, Xₚ₁/Xₚ₂, Xₚ₃) are broken down into bit sequences (BIF) completely.

In some embodiments, the classification is performed for multiple segments of bit sequences (BIF), the bit sequences (BIF) collectively preferably forming the at least one file (FIL).

In some embodiments, the candidate file classes into which the bit sequences (BIF) are classified are ascertained together with the position (t) of the respective bit sequence (BIF) within the file (FIL).

In some embodiments, the file class (CLA0, CLA1) is determined in such a way that the candidate file class into which most bit sequences (BIF) are classified is determined as the file class (CLA0, CLA1).

In some embodiments, the file class (CLA0, CLA1) is determined in such a way that, for each candidate file class, an average value of a measure of the affiliation of the bit sequence (BIF) to this candidate file class, which the first neural network (NN) assigns to the bit sequence (BIF), and/or a characteristic of this measure along the position (t) of the bit sequence (BIF) within the file (FIL), in particular an accumulation of values of this measure at specific positions (t) and/or local variances and/or statistical irregularities of values of this measure, is/are ascertained and used to determine the file class (CLA0, CLA1).

In some embodiments, the file class (CLA0, CLA1) is determined by means of a second neural network (NN2), to which are transmitted as input data, for each bit sequence, preferably the candidate file class into which said bit sequence has been classified by the neural network (NN) and/or, for each file class, a measure of the affiliation of the bit sequence to this candidate file class, which the first neural network assigns to the bit sequence, preferably together with the position (t).

As another example, some embodiments include a file classification device having at least one first neural network (NN) that has been trained by means of a method as described herein and/or that is designed to carry out a method for classifying at least one file as described herein.

As another example, some embodiments include a method for increasing the IT security of an automation and/or production facility that uses one or more files, wherein the one or more files are classified by means of a method for classifying at least one file (FIL) into file classes as described herein and/or by means of a file classification device as described herein and wherein an IT security property of the one or more files is used as a file class, and the file class into which the file is classified is taken as a basis for taking an IT security measure.

In some embodiments, the IT security is a functional safety and/or a data security and/or the IT security property affects the data security and/or functional safety of the automation facility that uses the one or more files.

### BRIEF DESCRIPTION OF THE DRAWINGS

The teachings of the present disclosure are outlined in more detail below on the basis of an exemplary embodiment that is shown in the drawing, in which:

FIG. 1 shows a flowchart for an example method for training a neural network to classify file types incorporating teachings of the present disclosure; and

FIG. 2 schematically shows a block diagram of an example file classification device incorporating teachings of the present disclosure.

### DETAILED DESCRIPTION

Some teachings of the present disclosure include a method for training a neural network to classify files into file classes, a plurality of test files are used, each of which is assigned to a file class, each of the test files being broken down into bit sequences that remain assigned to the previously associated file class, and the neural network being trained using the bit sequences. This method allows neural networks to be used, unlike what has been known previously, to identify file classes very flexibly by suitably training neural networks using test files. The test files, i.e. the training files, are conditioned in such a way that the neural network does not have to orient its verdict to a very specific, rigidly defined pattern in the content of the test files, for instance of the type “the third byte always has the value 17”. Rather, the neural network may orient itself much more intensely than has been known previously to structural properties of the content of the test content.

The test files broken down into bit sequences are used to train the neural network specifically to classify the content of the test files on the basis of general structural features, for instance “a comma occurs in the file at more or less regular intervals”. The neural network therefore cannot be geared to rigid patterns that can no longer, or at least no longer reliably, be recognized when this pattern changes, for instance as a result of adaptation of a file format due to new file versions or new file standards.

Using the methods described herein, the classification instead remains robust in the face of changes made in the file formats at a time after training, so long as at least the fundamental structure of the file content is maintained. By contrast, a conventional classification that looks only for the string ‘%PDF’ at the beginning of the file, for instance, works perfectly only so long as the string occurs there in precisely this form. If this string is altered just minimally, however, or moved to a different location in a new version of the format, the recognition rule no longer works at all. A first neural network can therefore be trained in a much improved manner compared to the prior art. The neural network trained in this way is designed for flexible classification that has little susceptibility to adaptations of file formats. The neural network can thus be trained much more efficiently by means of the methods described herein, and the neural network so trained works much more flawlessly.

In some embodiments, the training files are broken down into bit sequences completely. In other words, each bit of the training files is conveniently adopted in at least one bit sequence that is used to train the neural network. In this way, all the information that the training files contain is used to train the neural network.

The neural network may be trained using the bit sequences in an unordered succession, in particular in a randomized succession. This prevents the neural network from interpreting the succession of the bit sequences themselves as information and therefore from attaching an importance to this succession of the bit sequences that can influence the classification by means of the neural network. By means of the unordered, in particular randomized, succession, the succession does not form a pattern that can be evaluated by the neural network. Instead, the neural network is trained to use more general structural features identifiable in the bit sequence for classification.

In some embodiments, the neural network is a recurrent first neural network, i.e. a first neural network known as a “recurrent neural network”. A “recurrent neural network” such as this has a type of “memory” and therefore has the opportunity to use a preceding number of bits of a bit sequence in the classification decision for the current bit sequence. This allows, in particular, the neural network to be applied to bit sequences of any length instead of being limited to bit sequences of fixed length from the outset on account of its input format. Additionally, bit sequences of fixed length would lead, during training, to the network having to independently learn every structural relationship between successive bits for each position within the stipulated block length, whereas, when recurrent networks are used, a relationship with the local context, i.e. with the “prehistory” of the last bit sequences, is learnt from the outset regardless of the exact position of the current bit sequence within the file.

In the methods for classifying at least one file into file classes, a first neural network that has been or is trained as described herein is used and at least two different segments from the file in the form of bit sequences are used in the method and the bit sequences are each classified into candidate file classes using the first neural network, and the candidate file classes are taken as a basis for determining a file class. Since a first neural network trained as described herein is used, the method can advantageously be used to classify files flexibly, i.e. in a manner that is robust in the face of adaptations of a particular file format.

In some embodiments, the files are broken down into bit sequences completely. Thus, all the information that a file contains is used to classify the file. The reliability of the classification of the file is improved further in this development.

In some embodiments, the classification is performed for multiple different bit sequences of the respective at least one file, the bit sequences collectively preferably forming the at least one file. The multiple different bit sequences can be used to better exploit the information content of the file. In particular if the multiple different bit sequences collectively form the respective file, the entire available content of the file is used for classification.

The candidate file classes into which the bit sequences are classified are ascertained together with the position of the respective bit sequence within the file. In this way, the position of the bit sequence can be used as additional information for final classification of the file. The file class, i.e. the end result-based on the candidate file classes—of the classification method, is fittingly determined in such a way that, for a particular file, the candidate file class into which most bit sequences are classified is determined as the file class for this file.

In some embodiments, the file class is determined in such a way that, for each candidate file class, a measure of an affiliation of the bit sequence to this candidate file class, which the first neural network assigns to the bit sequence, is ascertained and used to determine the file class. Such a measure of an affiliation of the bit sequence to this candidate file class can also be referred to as a classification value. The classification value normally forms a number between 0 and 1 and denotes a clear association with the respective candidate file class, for instance by means of a value closer to 0 or closer to 1, whereas an unclear association is often expressed by means of values close to 0.5.

Such a measure of the affiliation of the bit sequence to this candidate file class can be ascertained for the multiple bit sequences of the file, and used, in the form of an average value, in particular in the form of an arithmetic mean or a geometric mean or a square mean. In some embodiments, a characteristic of this measure of the affiliation of bit sequences to the candidate file class along their position within the file can be ascertained and used to determine the file class. In particular, the characteristic can be taken as a basis for ascertaining an accumulation of values of the measure at specific positions of the bit sequences and/or local variances and/or statistical irregularities of values of this measure and for using it/them to determine the file class.

In some embodiments, the file class is determined by means of a second neural network, to which are transmitted as input data, for each bit sequence, e.g. the candidate file class into which said bit sequence has been classified by the first neural network and/or, for each candidate file class, a measure of the affiliation of the bit sequence to this candidate file class, which the first neural network assigns to the bit sequence, preferably together with the position.

The file classification device has at least one first neural network that has been trained by means of a method for training a neural network to classify files into file classes as described herein, and/or that is designed to carry out a method for classifying at least one file into file classes as described herein.

In some embodiments, the file classification device is used so that an IT security property of files that affects a data security and/or functional safety of an automation facility that uses the files is used as a file class, and the file class into which the file classification device classifies the files is taken as a basis for taking an IT security measure. In some embodiments, the automation facility is a production facility. Conveniently, the IT security measure is providing the file with an intended IT security property if the classification by means of the file classification device reveals that the file does not have the intended IT security property, or limiting access rights for using or executing the file, or increased monitoring during use or execution of the file, if said file does not have the intended IT security property. In particular, malicious code in a file may be disguised using a protective tool. Identified prior application of a protective tool to a file can therefore mean that IT security is impaired. In some embodiments, it is considered to be an intended IT security property of a file that prior application of a protective tool such as this to this file has not occurred. Accordingly, the disclosure describes a method for increasing the IT security of an automation and/or production facility, wherein the classification of the file is used to detect a security property of the file and the detected security property is taken as a basis for taking an IT security measure for the automation and/or production facility.

In the methods for increasing the IT security of an automation and/or production facility that uses one or more file/s, the one or more file/s is/are classified by means of a method for classifying at least one file into file classes as described herein and/or by means of a file classification device as described herein, wherein an IT security property of the one or more file/s is used in the method as one of the file classes and the file class into which the one or more file/s are classified is taken as a basis for taking an IT security measure.

In some embodiments, the IT security is a functional safety and/or a data security and/or the IT security property affects the data security and/or functional safety of the automation facility that uses the one or more files. The one or more file/s may be configuration file/s and/or control file/s of the automation and/or production facility. In some embodiments, the security measure is providing the one or more file/s with an intended IT security property as described previously, or limiting access rights for using or executing the one or more file/s, or increased monitoring during use or execution of the one or more file/s, if said file/s do not have the intended IT security property. In particular, malicious code in a file may be disguised using a protective tool. Identified prior application of a protective tool to a file can therefore mean that IT security is impaired. In some embodiments, it is considered to be an intended IT security property of a file that prior application of a protective tool such as this to this file has not occurred.

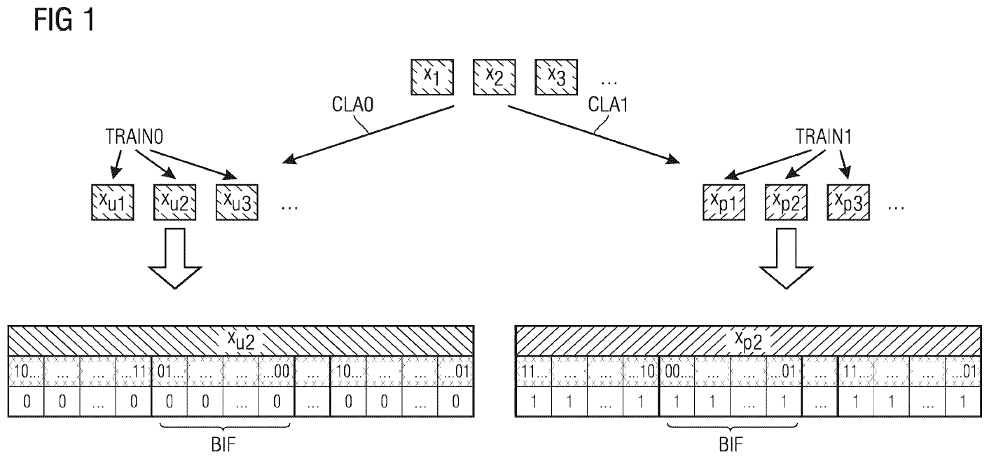

In the example method shown in FIG. 1, a first neural network NN is trained to classify file types. To this end, the neural network NN is consigned respective training data TRAIN0, TRAIN1 as input data, for which the neural network NN is supposed to ascertain and output a related classification in the form of file classes CLA0, CLA1 as a respective output datum.

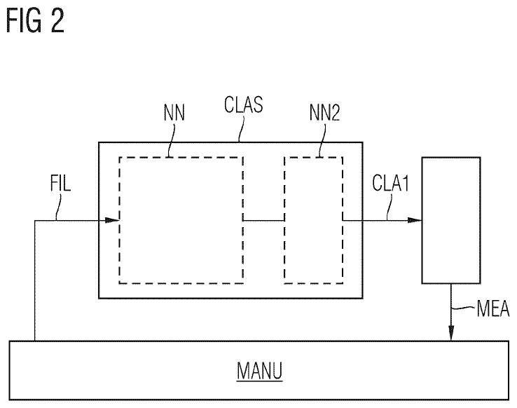

The training enables the neural network NN to sort a priori unknown files FIL (see FIG. 2) into the file classes CLA0, CLA1. For this purpose, the neural network is trained using a training data set TRAIN0 of training files Xᵤ₁, Xᵤ₂, Xᵤ₃, all of which are assigned to the file class CLA0, and using a training data set TRAIN1 of training data Xₚ₁, Xₚ₂, Xₚ₃, all of which are assigned to the file class CLA1.

Each training example therefore consists of a training file Xᵤ₁, Xᵤ₂, Xᵤ₃, Xₚ₁, Xₚ₂, Xₚ₃ and a label in the form of the file class CLA0, CLA1, the file class CLA0, CLA0 having a value 0 or 1 in the exemplary embodiment shown and indicating the file class to which the one training file Xᵤ₁, Xᵤ₂, Xᵤ₃, Xₚ₁, Xₚ₂, Xₚ₃ needs to be assigned for correct classification. The approach for training the neural network NN, for instance withholding a small portion of the training data for validation purposes, complies with customary standards in a manner known per se and will not be explained in more detail here.

In the exemplary embodiment, prior application of a protective tool to an executable binary file is supposed to be identified. Application of the protective tool would permit malicious code in the file to be disguised, which would potentially present a security risk for a device or a facility on which the file is supposed to be used. In this regard, the training data sets TRAIN0, TRAIN1 are provided in such a way that the protective tool is first of all not applied to a data set X₁, X₂, X₃, and so the result is the unaltered training data set TRAIN1 containing a set of unprotected training files Xᵤ₁, Xᵤ₂, Xᵤ₃ in the form of binaries, and, secondly, the protective tool is applied to the data set x₁, X₃, X₃, as a result of which the protected training files Xₚ₁, Xₚ₂, Xₚ₃, which likewise form binaries, are obtained. The training data set TRAIN0 thus comprises the training files Xᵤ₁, Xᵤ₂, Xᵤ₃ together with the file class CLA0 with the label “0”, denoting that these are unprotected training files. The training data set TRAIN1, on the other hand, comprises the training data Xₚ₁, Xₚ₂, Xₚ₃ together with the file class CLA1 with the label “1” (protected). The two training data sets TRAIN1, TRAIN1 collectively form the joint training data set T.

In some embodiments, the training data sets TRAIN0, TRAIN1 can, in principle, also be obtained in another way. As such, it is in particular not necessary for the training data set of one file class CLA1 to be based on the training data set of the other file class CLA0 at all. In other exemplary embodiments, it is also not necessary for precisely the same number of training files to be available for each individual file class; instead, the numbers of training files for the respective file class can also differ from one another in principle.

In some embodiments, the conditioning of the training files Xᵤ₁, Xᵤ₂, Xᵤ₃, Xₚ₁, Xₚ₂, Xₚ₃ in conducted such a way that the neural network NN has to orient its verdict to structural properties of the file content of the training files Xᵤ₁, Xᵤ₂, Xᵤ₃, Xₚ₁, Xₚ₂, Xₚ₃ to an increased degree and cannot be underpinned by very specific patterns of the particular file types CLA0, CLA1, for instance “the third byte always has the value 17”.

In some embodiments, all the training files Xᵤ₁, Xᵤ₂, Xᵤ₃, Xₚ₁, Xₚ₂, Xₚ₃ from the joint training data set T are each split into shorter bit sequences BIF. The splitting can be performed with uniform length, here for example 1 kilobyte, or with variable length for each bit sequence BIF. If the splitting at the end of a training file Xᵤ₁, Xᵤ₂, Xᵤ₃, Xₚ₁, Xₚ₂, Xₚ₃ does not work out, the leftover remainder of the training file Xᵤ₁, Xᵤ₂, Xᵤ₃, Xₚ₁, Xₚ₂, Xₚ₃ can be discarded, for example, or filled with dummy bits, for example zero bits.

Next, the shortened bit sequences BIF together with the labels for the file classes CLA0, CLA1 belonging to their respective training files Xᵤ₁, Xᵤ₂, Xᵤ₃, Xₚ₁, Xₚ₂, Xₚ₃ from which each of the bit sequences BIF comes, are compiled to produce the set of final training pairs; the set of final training pairs thus contains all the pairs of bit sequences BIF and labels for the file classes CLA0, CLA1 for all training examples of the joint training data set T. The order in which the bit sequences BIF and the related labels are presented to the neural network during training is subsequently randomized —as customary—at the start of each training epoch.

This approach may offer one or more of the following advantages:

In some embodiments, the neural network NN is generally not presented with an individual file “as a whole”, but rather the network receives individual files only in a manner limited to the length of the individual bit sequences BIF, and not in the correct order, but rather in any order. The neural network NN therefore cannot rely on the presence of specific values at particular positions in a file in order to classify the files and must instead use more general structural features identifiable in the segment of a bit sequence BIF for classification.

The training operation using the method shown also requires the neural network NN to be presented with a greater number of labels, that is to say of associated file classes CLA0, CLA1, overall for the same total volume of data in the input, specifically one label per bit sequence BIF instead of one per file of the data set x₁, X₂, X₃.

The bytes within the bit sequences BIF are consigned to the input layer of the neural network NN both during training and during later application not as ordinal values between 0 and 255 but rather as a sequence of 8 respective bits having values between 0 and 1. Otherwise, distortions would arise as a result of more significant bits of a byte being provided with an excessive proportion of the activation of an input neuron and less significant bits conversely being provided with too small a proportion. Actual significant patterns in less significant bits could then be drowned out for instance in the high random noise of more significant bits.

In the exemplary embodiment shown, the neural network NN is a so-called “recurrent neural network”, which has a type of “memory” and therefore has the opportunity to use preceding bytes BIF of a bit sequence in the classification decision for the current byte. This allows, in particular, the neural network to be applied to bit sequences BIF of any length instead of being limited to bit sequences BIF of fixed length from the outset on account of its input format. Additionally, bit sequences BIF of fixed length would lead, during training, to the neural network having to independently learn every structural relationship between successive bits of the file for each position within the stipulated block length, whereas, when a recurrent neural network NN is used, a relationship with the local context, i.e. the “prehistory” of the last bytes, is learnt from the outset regardless of the exact position of the current byte.

The exemplary embodiment shown can be extended in another exemplary embodiment to the effect that application of the neural network NN to the input data in the form of the file of the data set FIL delivers a continuous classification characteristic OB (t) for the entire file FIL by recording the output of the neural network after each byte BIF of the file FIL at position t. In some embodiments, the input data of the neural network NN can consist of a different number of bits, for instance only a single bit in each case instead of 8 bits for a byte BIF, so that even a bit-accurate output OB (t), where t denotes the bit position within the file FIL, becomes possible.

A final classification function f (OB (t)) is subsequently applied to the classification characteristic OB (t) ascertained by the network for the measure of the affiliation of the bit sequence to this candidate file class, which is ascertained for each bit sequence BIF within the file FIL. This classification function f (OB (t)) can be realized for instance as averaging in the form of an arithmetic mean or in the identification of a particular local accumulation of greatly differing values of the classification characteristic or in the identification of a local accumulation of similar values of the classification characteristic. In other exemplary embodiments, the classification may also be realized by means of a further neural network NN2 (see FIG. 2), however: as such, by way of example, the further neural network NN2 is trained to assign the correct label CLA0, CLA1 to the classification characteristic OB (t) that is output by the first neural network NN.

The example classification device CLAS shown in FIG. 2 uses the training of the first neural network NN described in the preceding embodiments, which consigns the classification characteristic OB (t) to the second neural network NN2. The second neural network NN2 ascertains the definitive file class, CLA0 in the case shown, therefrom and transmits the file class CLA0 to a measures device MEA.

The files FIL supplied to the first neural network NN for classification are read from a storage unit of a production device MANU of a production facility. The production device MANU uses the files FIL for production control. The measures device MEA takes the ascertained file class, i.e. takes the verdict of the classification device CLAS, as a basis for applying a protective function to the file FIL. If the classification device CLAS detects that a protective tool that could potentially disguise malicious code introduced into the file FIL has been applied to the file FIL, the protective function is applied. In the exemplary embodiment shown, the protective function is isolation of the file FIL to a secure environment, and intensive monitoring during use of the file FIL. If it is identified that a protective tool has not been applied to the file FIL, the security function is not applied. Accordingly, the invention can alternatively also be described as an application or method for increasing the IT security of a production facility.

What is claimed is:

1. A method for training a neural network to classify files into file classes, the method comprising:
assigning each file of a plurality of test files to a file class;
breaking down each of the files into bit sequences assigned to the previously associated file class; and
training the neural network using the bit sequences.

2. The method as claimed in claim 1, wherein the test files are completely broken down into bit sequences.

3. The method as claimed in claim 1, wherein training the neural network includes using the bit sequences in an unordered succession.

4. The method as claimed in claim 1, wherein the neural network comprises a recurrent neural network.

5. A method for classifying a file into a file class, with a trained neural network, the method comprising:
using at least two different segments from the file in the form of bit sequences;
classifying each of the bit sequences into candidate file classes using the trained neural network; and
using the candidate file classes a basis for determining a file.

6. The method as claimed in claim 5, further comprising breaking down the training files are completely broken down into bit sequences.

7. The method as claimed in claim 6, further comprising performing the classification for multiple segments of bit sequences.

8. The method as claimed in claim 5, further comprising ascertaining the candidate file classes into which the bit sequences are classified together with the position of the respective bit sequence within the file.

9. The method as claimed in claim 5, further comprising determining the file class in such a way that the candidate file class into which most bit sequences are classified is determined as the file class.

10. The method as claimed in claim 5, wherein the file class is determined in such a way that, for each candidate file class, an average value of a measure of the affiliation of the bit sequence to this candidate file class, which the neural network assigns to the bit sequence, and/or a characteristic of this measure along the position of the bit sequence within the file is ascertained and used to determine the file class.

11. The method as claimed in claim 5, wherein the file class is determined by a second neural network using input data, for each bit sequence, including the candidate file class into which said bit sequence has been classified by the neural network and/or, for each file class, a measure of the affiliation of the bit sequence to this candidate file class, which the first neural network assigns to the bit sequence.

12-14. (canceled)
